(19) United States
(12) Patent Application Publication
(10) Pub. No.: US 2018/0074985 A1
(43) Pub. Date: Mar. 15, 2018

(54) RADIO FREQUENCY FRONT END (RFFE) COMMAND CODE EXTENSION WITH UNIFORM SEQUENCE START CONDITION (SSC)

(71) Applicant: QUALCOMM Incorporated, San Diego, CA (US)

(72) Inventors: Lalan Jee Mishra, San Diego, CA (US); Helena Deirdre O'Shea, San Diego, CA (US); Richard Dominic Wietfeldt, San Diego, CA (US)

(21) Appl. No.: 15/696,567

(22) Filed: Sep. 6, 2017

Related U.S. Application Data
(60) Provisional application No. 62/385,470, filed on Sep. 9, 2016.

(51) Int. Cl. G06F 13/362; G06F 13/42

(52) U.S. Cl. CPC G06F 13/362; H04W 84/20; G06F 13/4247

(57) ABSTRACT

Radio Frequency Front End (RFFE) command code extensions with uniform start sequence condition (SSC) are disclosed. In one aspect, the RFFE protocol reserves one of the remaining reserved command codes as a command code extension command. In a first aspect, use of the command code extension command allows insertion of another command field after an existing command code and before a payload. The command code extension command may include the ability to nest plural command code extension commands providing multiple layers of commands so as to provide necessary and sufficient unused codes for future needs. In a second aspect, the command code extension command may allow a designation of a particular subset of commands to be associated with the command codes in the new command code field. In this aspect, command codes are reused with potentially different meanings based on which subset of commands was indicated.

### PRIORITY CLAIM

The present application claims priority to U.S. Provisional Patent Application Ser. No. 62/385,470 filed on Sep. 9, 2016 and entitled “RADIO FREQUENCY FRONT END (RFFE) COMMAND CODE EXTENSION WITH UNIFORM SEQUENCE START CONDITION (SSC),” the contents of which is incorporated herein by reference in its entirety.

### BACKGROUND

### I. Field of the Disclosure

The technology of the disclosure relates generally to radio frequency front end (RFFE) buses and particularly to commands thereon.

### II. Background

Computing devices have become increasingly common in modern society. Mobile phones are among the more common computing devices. While such devices may initially have started out as simple devices that allowed audio communication through the Public Land Mobile Network (PLMN) to the Public Standard Telephone Network (PSTN), they have evolved into smart phones capable of supporting full multimedia experiences as well as supporting multiple wireless protocols. Even within the cellular wireless protocols, mobile phone radios have developed into highly complex, multi-band, and multi-standard designs that often have multiple radio frequency (RF) signal chains. Every component in the RF signal chain has to be in the desired configuration at any given time, or the system will fail. Therefore, accurate timing, triggers, and speed are all necessary.

As further explained on the MIPI Alliance® website, “[t]he MIPI Alliance Specification for RF Front-End Control Interface (RFFE) was developed to offer a common and widespread method for controlling RF front-end devices. There are a variety of front-end devices, including Power Amplifiers (PA), Low-Noise Amplifiers (LNA), filters, switches, power management modules, antenna tuners and sensors. These functions may be located either in separate devices or integrated into a single device, depending on the application. The trend in mobile radio communications is towards complex multi-radio systems comprised of several parallel transceivers. This implies a leap in complexity of the RF front-end design. Thus, the RFFE bus must be able to operate efficiently in configurations from the simplest one Master and one Slave configuration to, potentially, multi-Master configurations with tens of Slaves.”

In devices having an RFFE bus, the RFFE protocol dictates that the master sends commands to the slaves using command codes. In version 2 of the RFFE protocol, eight bits were allocated for command codes, corresponding to 256 command codes. Various updates to the protocol have essentially exhausted the available command codes. As of this writing, there are fewer than ten unused command codes. Many commands are currently not implemented in the RFFE protocol, including polled interrupts, ACK commands, latency commands, and the like. The few remaining unused command slots are numerically insufficient to cover all currently possibly desired commands to say nothing of future desired commands. Accordingly, there is a need to be able to expand the number of available command codes without redefining the command code portion of the specification.

### SUMMARY OF THE DISCLOSURE

Aspects disclosed in the detailed description include Radio Frequency Front End (RFFE) command code extensions with uniform start sequence condition (SSC). In particular, exemplary aspects of the present disclosure contemplate reserving one of the remaining reserved command codes as a command code extension command. In a first aspect, use of the command code extension command allows insertion of another command field after the existing command code and before a payload. The command code extension command may include the ability to nest plural command code extension commands providing multiple layers of commands so as to provide necessary and sufficient unused codes for future needs. In a second aspect, the command code extension command may allow a designation of a particular subset of commands to be associated with the command codes in the new command code field. In this aspect, command codes are reused with potentially different meanings based on which subset of commands was indicated.

In this regard in one aspect, a method for expanding commands available on an RFFE system is disclosed. The method includes using a reserved command code to indicate a command code extension command. The method also includes creating an extension command frame. The method also includes populating the extension command frame with a command code inside a command extension range.

In another aspect, a master device in an RFFE system is disclosed. The master device includes a bus interface. The master device also includes a transmitter configured to send packets through the bus interface onto an RFFE bus. The master device also includes a control system. The control system is configured to use a reserved command code to indicate a command code extension command. The control system is also configured to create an extension command frame. The control system is also configured to populate the extension command frame with a command code inside a command extension range.

In another aspect, a method for processing commands on an RFFE system is disclosed. The method includes receiving a packet. The method also includes evaluating a command code in the packet to determine if a command code extension command is used therein. The method also includes, when the command code extension command is used, evaluating a command within an extension command frame.

In another aspect, a slaved device in an RFFE system is disclosed. The slave device includes a bus interface. The slaved device also includes a transceiver configured to receive packets through the bus interface from an RFFE bus. The slave device also includes a control system. The control system is configured to evaluate a command code in a packet to determine if a command code extension command is used therein. The control system is also configured to, when the command code extension command is used, evaluate a command within an extension command frame.

### BRIEF DESCRIPTION OF THE FIGURES

FIG. 1 is system-level block diagram of an exemplary mobile terminal configured to communicate based on MIPI Alliance® (MIPI) defined architecture;

FIG. 2 illustrates a conventional Radio Frequency Front End (RFFE) packet according to the MIPI Alliance defined RFFE protocol;

FIG. 3 illustrates a first exemplary RFFE packet having a command code extension command in the primary command frame and an additional command frame;

FIG. 4 illustrates a second exemplary RFFE packet having nested command code extension commands to create a third command frame;

FIG. 5 illustrates a third exemplary RFFE packet having selectable command sets in a second command frame;

FIG. 6 illustrates an exemplary integrated circuit (IC) that may be coupled to an RFFE bus and configured to send and/or receive RFFE packets having the extended command sets of the present disclosure;

FIG. 7 is a flowchart illustrating an exemplary process for using expanded command code commands by a master; and

FIG. 8 is a flowchart illustrating an exemplary process for extracting expanded command code commands at a slave.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include Radio Frequency Front End (RFFE) command code extensions with uniform start sequence condition (SSC). In particular, exemplary aspects of the present disclosure contemplate reserving one of the remaining reserved command codes as a command code extension command. In a first aspect, use of the command code extension command allows insertion of another command field after the existing command code and before a payload. The command code extension command may include the ability to nest plural command code extension commands providing multiple layers of commands so as to provide necessary and sufficient unused codes for future needs. In a second aspect, the command code extension command may allow a designation of a particular subset of commands to be associated with the command codes in the new command code field. In this aspect, command codes are reused with potentially different meanings based on which subset of commands was indicated.

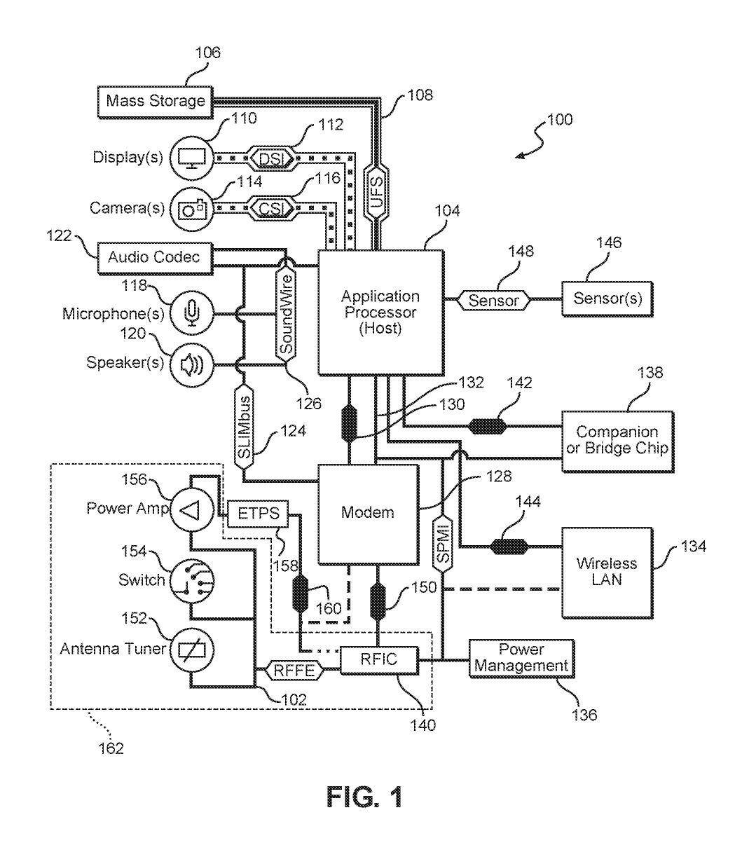

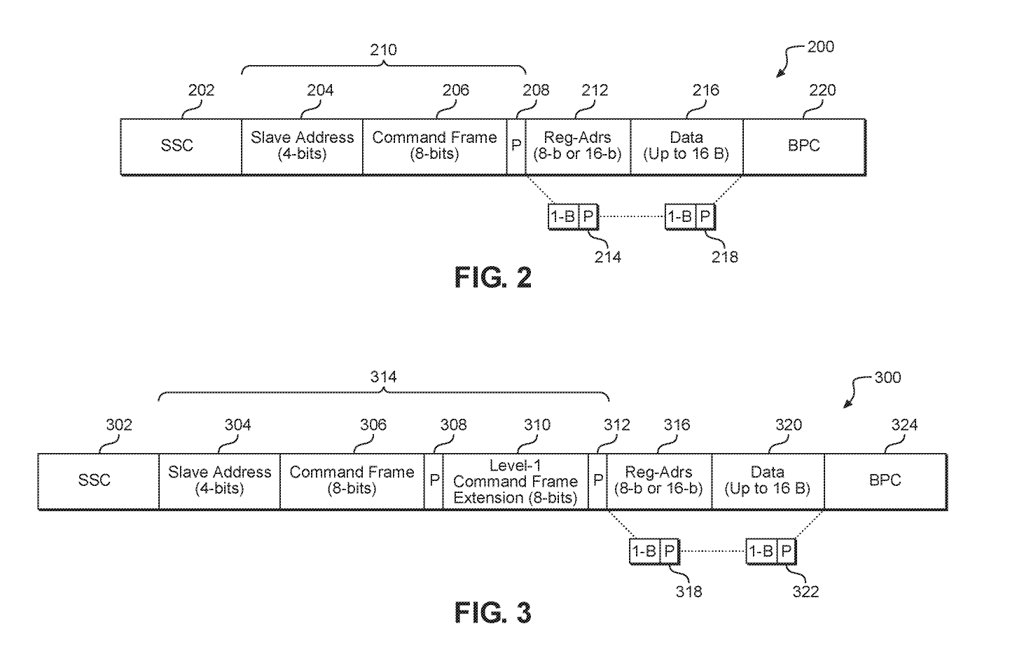

Before discussing exemplary aspects of command code extension commands according to specific aspects of the present disclosure, a brief overview of a mobile terminal configured based on MIPI Alliance® (MIPI) defined architecture is first provided in FIG. 1. A basic RFFE packet is described with reference to FIG. 2 to show conventional command codes. The discussion of specific exemplary aspects of the command code extension commands within an RFFE packet starts with reference to FIG. 3.

In this regard, FIG. 1 is system-level block diagram of an exemplary mobile terminal 100 such as a smart phone, mobile computing device tablet, or the like. While a mobile terminal is particularly contemplated as being capable of benefiting from exemplary aspects of the present disclosure, it should be appreciated that the present disclosure is not so limited and may be useful in any system having a bus that has multiple masters and needing priority-based bus access with minimal latency. For the sake of illustration, it is assumed that an RFFE bus 102 within the mobile terminal 100 is among multiple communication buses configured to support RFFE command code extension with uniform SSC according to the present disclosure.

With continued reference to FIG. 1, the mobile terminal 100 includes an application processor 104 (sometimes referred to as a host) that communicates with a mass storage element 106 through a universal flash storage (UFS) bus 108. The application processor 104 may further be connected to a display 110 through a display serial interface (DSI) bus 112 and a camera 114 through a camera serial interface (CSI) bus 116. Various audio elements such as a microphone 118, a speaker 120, and an audio codec 122 may be coupled to the application processor 104 through a serial low power interchip multimedia bus (SLIMbus) 124. Additionally, the audio elements may communicate with each other through a SOUNDWIRE™ bus 126. A modem 128 may also be coupled to the SLIMbus 124. The modem 128 may further be connected to the application processor 104 through a peripheral component interconnect (PCI) or PCI express (PCIe) bus 130 and/or a system power management interface (SPMI) bus 132.

With continued reference to FIG. 1, the SPMI bus 132 may also be coupled to a wireless local area network (WLAN) integrated circuit (IC) (WLAN IC) 134, a power management integrated circuit (PMIC) 136, a companion integrated circuit (sometimes referred to as a bridge chip) 138, and a radio frequency integrated circuit (RFIC) 140. It should be appreciated that separate PCI buses 142 and 144 may also couple the application processor 104 to the companion integrated circuit 138 and the WLAN IC 134. The application processor 104 may further be connected to sensors 146 through a sensor bus 148. The modem 128 and the RFIC 140 may communicate using a bus 150.

With continued reference to FIG. 1, and of particular interest for the present disclosure, the RFIC 140 may couple to one or more RFFE elements, such as an antenna tuner 152, a switch 154, and a power amplifier 156 through the RFFE bus 102. Additionally, the RFIC 140 may couple to an envelope tracking power supply (ETPS) 158 through a bus 160, and the ETPS 158 may communicate with the power amplifier 156. Collectively, the RFFE elements, including the RFIC 140, may be considered an RFFE, system 162. It should be appreciated that the RFFE bus 102 may be formed from a clock line and a data line (not illustrated).

FIG. 2 illustrates a conventional RFFE packet 200 which begins with an SSC 202. According to the RFFE, protocol, the SSC 202 corresponds to a master device pulling the data line of the RFFE bus 102 high while the clock line is kept low. Following the SSC 202, an address frame 204 is provided. According to the RFFE protocol, the address frame 204 provides a slave address, which is four bits (4-bits) long. The master device populates the address frame 204 with an address for a slave to which the RFFE packet 200 is being sent. Following the address frame 204, a command frame 206 is provided. The command frame 206 holds eight bits (8-bits) into which the master device populates a command according to a list of commands predefined by the RFFE protocol. Currently there are fewer than ten reserved command codes that have not been assigned functions. A parity bit 208 follows the command frame 206. Collectively, the address frame 204, the command frame 206, and the parity bit 208 form a frame header 210. A register address 212 follows the parity bit 208. The register address 212 may be eight bits (8-bits) or sixteen bits (16-bits) and may be followed by a parity bit 214. Following the parity bit 214, data 216 is provided. The data 216 may be up to sixteen bytes (16 B) and conclude with a parity bit 218. Following the parity bit 218 is a bus park cycle (BPC) 220.

Exemplary aspects of the present disclosure take one of the few remaining reserved command codes and designate that command code as a command code extension command. As of this writing, the available reserved command codes are 00010000-00011011. Any of these reserved command codes would be acceptable. In a first exemplary aspect, the command code extension command is followed by another command field that has another 256 available command codes to be defined. One of these may duplicate the command code extension command, allowing further nesting of additional command fields. In a second exemplary aspect, the command code extension command indicates which palette of additional command codes are used in a second command field. These aspects are explored in greater detail below with reference to FIGS. 3-5.

In this regard, FIG. 3 illustrates an expanded RFFE packet 300, which begins with an SSC 302. Following the SSC 302, an address frame 304 is provided. Following the address frame 304, a command frame 306 is provided. The command frame 306 holds eight bits (8-bits) into which the master device populates a command code extension command defined from amongst the reserved command codes. A parity bit 308 follows the command frame 306. Following the parity bit 308, an extension command frame 310 is provided. The extension command frame 310 may be any number of pre-defined bits, but, in an exemplary aspect, is eight bits (8-bits) long. This will provide an additional 256 commands capable of being defined as needed or desired. A parity bit 312 follows the extension command frame 310. Collectively, the address frame 304, the command frame 306, the parity bit 308, the extension command frame 310, and the parity bit 312 form a frame header 314. A register address 316 follows the parity bit 312. The register address 316 may be eight bits (8-bits) or sixteen bits (16-bits) and may be followed by a parity bit 318. Following the parity bit 318, data 320 is provided. The data 320 may be up to sixteen bytes (16 B) and conclude with a parity bit 322. Following the parity bit 322 is a BPC 324.

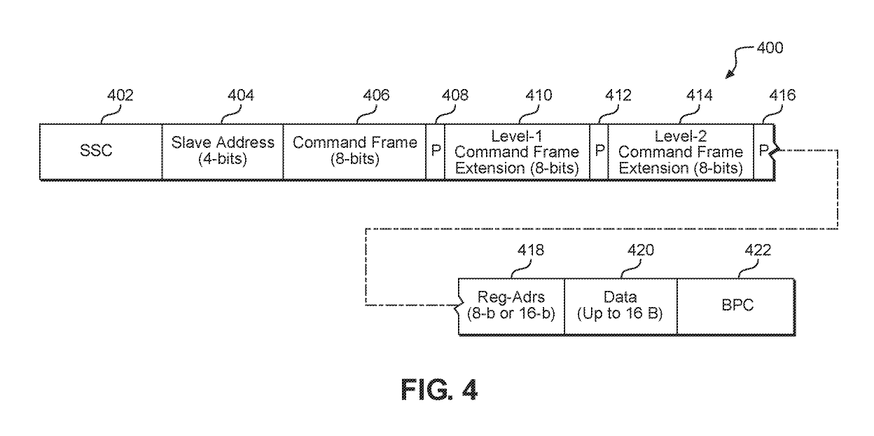

Instead of allowing 256 new commands, one command may be pre-emptively assigned to a command code extension command to allow nesting of command extension capabilities. In this regard, FIG. 4 illustrates a second exemplary RFFE, packet 400 having nested command code extension commands to create a third command frame. In particular, the RFFE packet 400 begins with an SSC 402. Following the SSC 402, an address frame 404 is provided. Following the address frame 404, a command frame 406 is provided. The command frame 406 holds eight bits (8-bits) into which the master device populates a command code extension command defined from amongst the reserved command codes. A parity bit 408 follows the command frame 406. Following the parity bit 408, a first extension command frame 410 is provided. The extension command frame 410 may be any number of pre-defined bits, but, in an exemplary aspect, is eight bits (8-bits) long. In this exemplary aspect, the extension command frame 410 is populated with the command code extension command causing a further parity bit 412 and third extension command frame 414 to be created after the first extension command frame 410. This third extension command frame 414 will provide an additional 256 commands capable of being defined as needed or desired. A parity bit 416 follows the third extension command frame 414. A register address 418 follows the parity bit 416. The register address 418 may be eight bits (8-bits) or sixteen bits (16-bits) and may be followed by a parity bit (not shown). Following the parity bit, data 420 is provided. The data 420 may be up to sixteen bytes (16 B) and conclude with a parity bit (not shown). Following the parity bit is a BPC 422.

It should be appreciated that further nested command code extension commands and corresponding frames may be created to create essentially limitless opportunities to define new commands. While the addition of the extra command code frames may add to latency, the functionality and versatility of the extra command codes may make the latency penalty acceptable.

Instead of nesting plural command frames, another exemplary aspect of the present disclosure allows the use of a reserved command code to select from a palette of commands. For example, if 0001000 were used, the next extension command frame would correspond to one set of commands, but if 00010001 were used, the next extension command frame would correspond to a different set of commands. Thus, if the command sequence was 00010000P11100111, an ACK might be sent, but if the command sequence was 00010001P11100111, a polling interrupt may be the command. It should be appreciated that instead of using an entire reserved command code for each palette of commands, the command code extension command could trigger an extension command frame and the first few bits may be used to designate to which palette the remaining bits correspond. Still other arrangements for selecting the palette of commands may also be used.

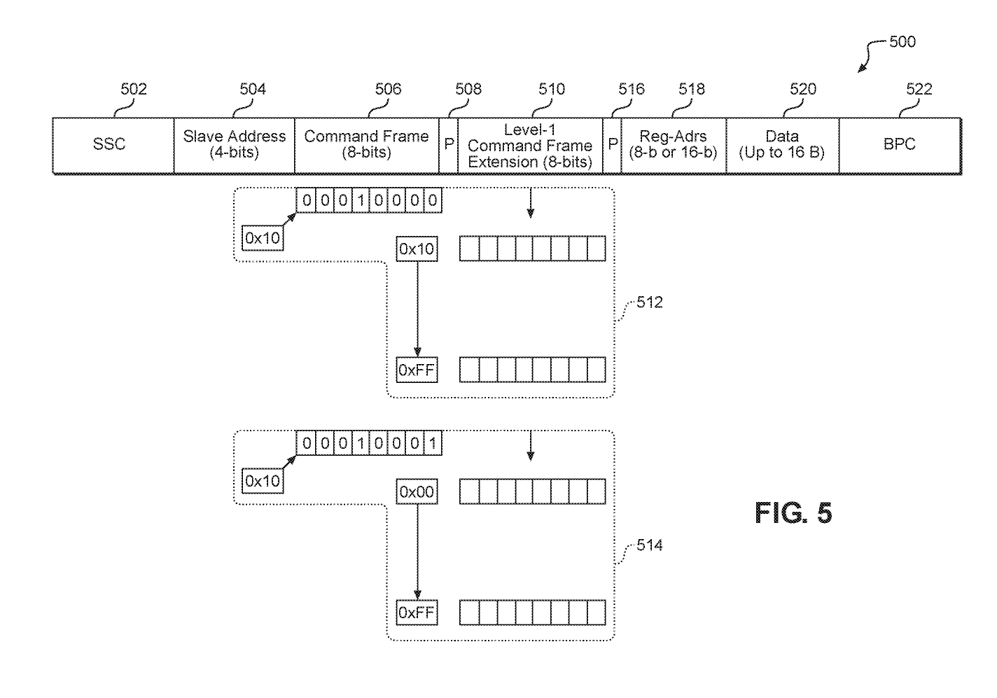

FIG. 5 illustrates a third exemplary RFFE packet 500 having selectable command sets in a second command frame. In particular, the RFFE packet 500 begins with an SSC 502. Following the SSC 502, an address frame 504 is provided. Following the address frame 504, a command frame 506 is provided. The command frame 506 holds eight bits (8-bits) into which the master device populates a command code extension command defined from amongst the reserved command codes. A parity bit 508 follows the command frame 506. Following the parity bit 508 a first extension command frame 510 is provided. The first extension command frame 510 may be any number of pre-defined bits, but, in an exemplary aspect, is eight bits (8-bits) long. If a first reserved command code (e.g., 00010000) is used, then the bits in the first extension command frame 510 correspond to a first palette of commands 512. If a second reserved command code (e.g., 00010001) is used, then the bits in the first extension command frame 510 correspond to a second palette of commands 514. It should be appreciated that further reserved command codes could be used to correspond to further palettes (not illustrated). Likewise, palette designation may be embedded within the bits of the first extension command frame 510. A parity bit 516 follows the first extension command frame 510. A register address 518 follows the parity bit 516. The register address 518 may be eight bits (8-bits) or sixteen bits (16-bits) and may be followed by a parity bit (not shown). Following the parity bit, data 520 is provided. The data 520 may be up to sixteen bytes (16 B) and conclude with a parity bit (not shown). Following the parity bit is a BPC 522.

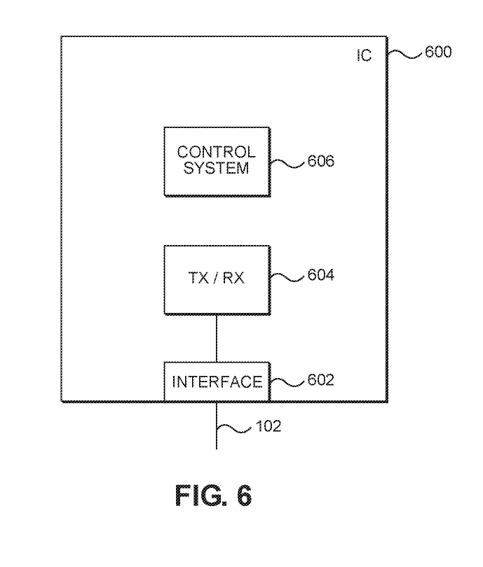

In the interests of further explication, FIG. 6 provides a block diagram of an IC 600 that may be coupled to the RFFE bus 102 of FIG. 1 and communicate thereover using command code extension commands. It should be appreciated that the IC 600 may be a master or slave device and may send the command code extension commands or receive the command code extension commands so as to act thereon. The IC 600 includes an interface 602 configured to couple to the RFFE bus 102. The interface 602 is communicatively coupled to a transceiver (Tx/Rx) 604, which is controlled by a control system 606. Software such as a driver or the like may interoperate with the control system 606 to detect when it is appropriate to use a command code extension command or to detect receipt of a command code extension command.

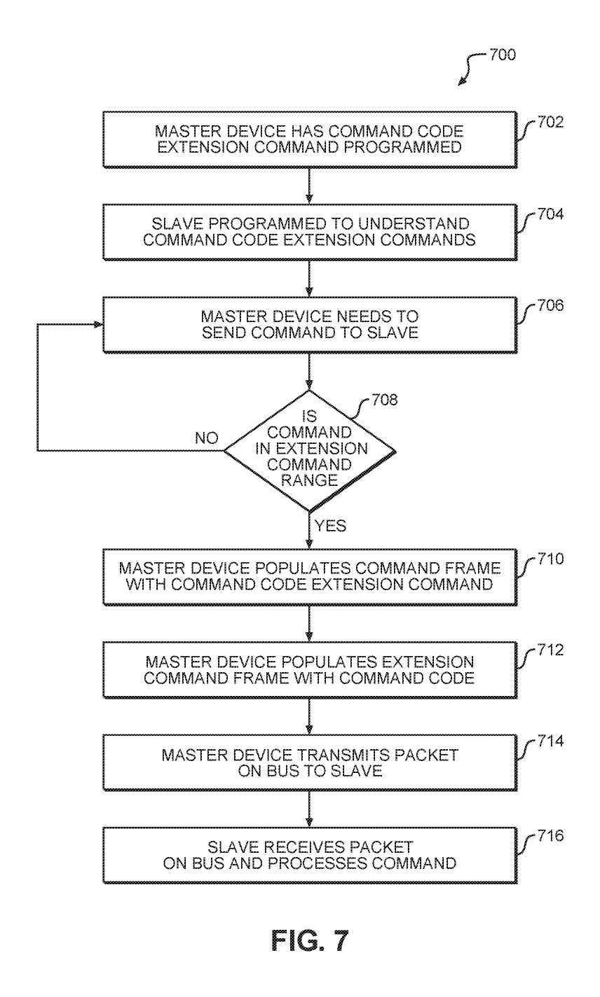

FIG. 7 is a flowchart illustrating an exemplary process 700 for using expanded command code commands. The process 700 begins with the master device within the RFFE system 162 of FIG. 1 having a command code extension command programmed (block 702). Likewise, one or more slaves within the RFFE system 162 are programmed to understand command code extension commands as well as command codes that fall within a command extension range (i.e., they are not in the base 256 commands authorized currently by the RFFE protocol) (block 704). At some point during operation, the master device will need to send a command to a slave (block 706). The master device determines whether the command is in the command extension range (i.e., outside the original 256 commands authorized in the RFFE protocol) (block 708). If the answer is no, the command is not inside the command extension range, the RFFE protocol dictates operation and nothing unusual happens. If the answer is yes, the command is inside the command extension range, then the master device populates the command frame with a command code extension command (block 710). The master device then populates the extension command frame with a command code (block 712). The master device finishes assembly of the packet and transmits the packet on the bus to the slave (block 714). The slave receives the packet on the bus and processes the command (block 716).

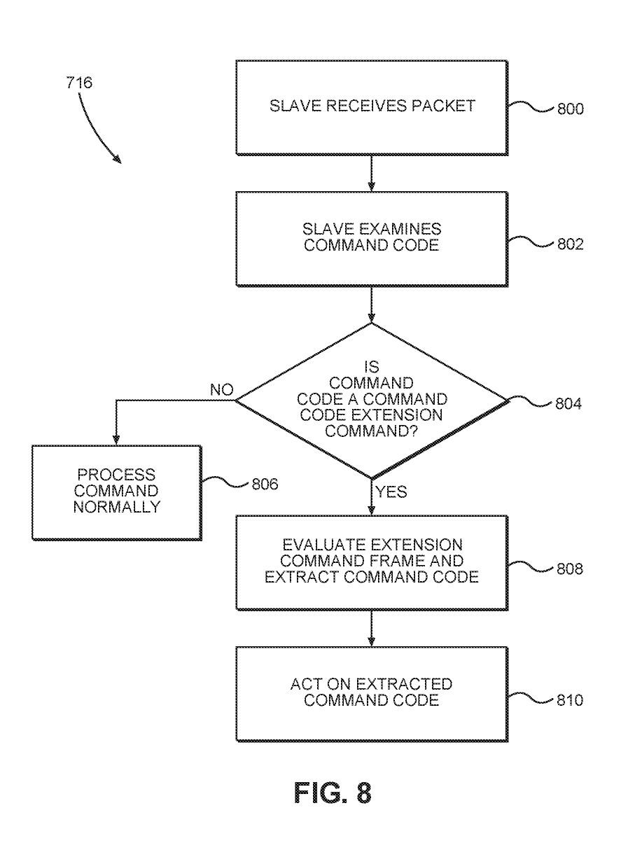

From the other side, FIG. 8 illustrates block 716 where the slave receives the packet (block 800) and examines the command code therein (block 802). In particular, the control system of the slave determines if the command code is a command code extension command (block 804). If the answer is no, then the slave processes the command normally (block 806). If, however, the answer is yes, that the command code is a command code extension command, then the slave evaluates the extension command frame and extracts the command code therein (block 808). The slave then acts on the extracted command code (block 810).

Note that the present disclosure is backwards compatible in that if a master device sends a command code extension command to a slave that is not programmed to recognize such command, the RFFE protocol instructs the slave to ignore commands in the command frame that are not understood.

While not explicitly illustrated, it should be appreciated that master and slave devices include transmitters, receivers, control systems, and a bus interface necessary and sufficient to operate on the RFFE bus as is well understood. The command codes that are within the command extension range may be stored in a look-up table or other data structure comparable to the structures used for the existing command codes.

The RFFE command code extension with uniform SSC according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for expanding commands available on a Radio Frequency Front End (RFFE) system, the method comprising:
using a reserved command code to indicate a command code extension command;
creating an extension command frame; and
populating the extension command frame with a command code inside a command extension range.

2. The method of claim 1, wherein populating the extension command frame comprises populating the extension command frame with a second command code extension command and further comprising creating a second nested extension command frame.

3. The method of claim 1, wherein using the reserved command code comprises selecting from a plurality of reserved command codes, each of the plurality of reserved command codes indicating a different palette of extension commands for population of the extension command frame.

4. The method of claim 1, wherein creating the extension command frame comprises creating an eight-bit extension command frame.

5. A master device in a Radio Frequency Front End (RFFE) system, the master comprising:
a bus interface;
a transmitter configured to send packets through the bus interface onto an RFFE bus; and
a control system configured to:
use a reserved command code to indicate a command code extension command;
create an extension command frame; and
populate the extension command frame with a command code inside a command extension range.

6. The master device of claim 5, wherein the control system is configured to populate the extension command frame with a second command code extension command and further configured to create a second nested extension command frame.

7. The master device of claim 5, wherein the control system is configured select from a plurality of reserved command codes, each of the plurality of reserved command codes indicating a different palette of extension commands for population of the extension command frame.

8. The master device of claim 5, wherein the control system is configured to create an eight-bit extension command frame.

9. The master device of claim 5 integrated into an integrated circuit (IC).

10. The master device of claim 5 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A method for processing commands on a Radio Frequency Front End (RFFE) system, the method comprising,
receiving a packet;
evaluating a command code in the packet to determine if a command code extension command is used therein; and
when the command code extension command is used, evaluating a command within an extension command frame.

12. The method of claim 11, further comprising, when the command code extension command is not used, processing the command code.

13. The method of claim 11, further comprising evaluating nested extension command frames to find a command.

14. The method of claim 11, further comprising determining a palette of commands based on the command code extension command.

15. The method of claim 14, further comprising determining a command based on the palette.

16. A slave device in a Radio Frequency Front End (RFFE) system, the slave comprising:
a bus interface;
a transceiver configured to receive packets through the bus interface from an RFFE bus; and
a control system configured to:
evaluate a command code in a packet to determine if a command code extension command is used therein; and
when the command code extension command is used, evaluate a command within an extension command frame.

17. The slave device of claim 16, wherein the control system is further configured to, when a command code extension command is not used, process the command code.

18. The slave device of claim 16, wherein the control system is further configured to evaluate nested extension command frames to find a command.

19. The slave device of claim 16, wherein the control system is further configured to determine a palette of commands based on the command code extension command.

20. The slave device of claim 16 integrated into an integrated circuit (IC).

21. The slave device of claim 16 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
